(19) United States
(12) Patent Application Publication
(10) Pub. No.: US 2002/0147614 A1
(43) Pub. Date: Oct. 10, 2002

(54) Physician decision support system with improved diagnostic code capture

(76) Inventors: Thomas D. Doerr, Saint Louis, MO (US); Kevin Stehlin, Saint Charles, MO (US); Richard Reichley, Saint Louis, MO (US); Michelle Hadley, Saint Peters, MO (US)

Correspondence Address: QUARLES & BRADY LLP, 411 E. WISCONSIN AVENUE, SUITE 2040, MILWAUKEE, WI, 53202-4497, US

(21) Appl. No.: 09/825,969

(22) Filed: Apr. 4, 2001

(51) Int. Cl. G06F 17/60

(52) U.S. Cl. 705/2

(57) ABSTRACT

A patient-side support system provided physician support materials keyed to detailed diagnosis codes. The support materials encourage the physician to provide detailed records without additionally burdening the physician's practice thus providing a solid basis for outcome-based evaluation different treatments in a practice group.

### CROSS-REFERENCE TO RELATED APPLICATIONS

### STATEMENT REGARDING FEDERALLY SPONSORED RESEARCH OR DEVELOPMENT

### BACKGROUND OF THE INVENTION

The rapid pace of advance in medicine places a great burden on physicians who wish to stay current on the latest research to be more effective in making diagnoses and informing their patients. Six million medical articles are published each year, over fifteen thousand per day. The Medline medical journal indexing system, which filters out lesser medical journals, still contains eleven million articles. In addition, there are over 20,000 medical and health web sites on the Internet.

Physicians may improve their medical practice through observing their patient's response to treatments and conferring with their colleagues about the experiences of their colleague's patients. Such “outcome-based” medicine can be expanded by a record keeping system that tracks diagnoses and outcomes for different treatments so that many physicians can share this data.

Ideally, in such a scalable outcome-based medicine system, each physician enters each diagnosis made by the physician together with the recommended treatment and a follow-up outcome of the treatment. These records, combining the experiences of many physicians over a variety of practice areas, provide valuable information about treatment efficacy.

Unfortunately it is not a simple matter to collect such records. Physicians are under great time pressure, and stopping to enter data is disruptive to their workflow. Further, entering accurate information requires the physician to choose among some 16,000 possible diagnosis codes and thousands of drug treatments and treatment regimes. This is an impractical burden.

Physicians and their staff have no practical, meaningful incentives to code accurately. They have financial incentives to select diagnosis codes that are likely to win easy reimbursement from payers, and they have very vague threats of regulatory persecution if their codes do not match their office visit patient records. Consequently, at present many physicians delegate the task of diagnosis coding to medical assistants who lack formal training in this area. Over time, medical assistants tend to create and select from a small pool of diagnosis codes that, in their experience, have resulted in hassle-free reimbursement from payers.

Accordingly, most outcome-based systems collect relatively coarse and inaccurate diagnosis data and rely heavily on prescription data from which diagnoses are deduced. These systems are particularly prone to inaccuracy for prescribed drugs that are used for treatment in multiple different diagnoses. Inaccurate diagnosis information can obscure important conclusions about treatment efficacy.

### SUMMARY OF THE INVENTION

The present invention provides a system for capturing detailed diagnosis and treatment information in a manner that minimizes disruption to the physician's workflow. Any minor disruption is offset by the systems' ability to provide several physician support features that enhance productivity. These physician support features are driven by the diagnosis information. To make this possible, the invention provides several alternative methodologies by which the physician may zero in on specific diagnosis codes with minimum effort. In this way, diagnostic code information may be captured in a manner that is neither disruptive nor disadvantageous to the individual practitioner.

Specifically, the present invention provides a patient-side decision support system having a hand-held terminal usable during examination and providing a display and user input device. A terminal server communicates with the hand-held terminal and executes a stored program to: (a) present on the display of the hand-held terminal a navigation menu presenting diagnosis codes representing different medical diagnoses; (b) accept from the user input device of the hand-held terminal a selection identifying a specific diagnosis code from the diagnosis codes; and (c) only after identification of a specific diagnosis code, enable for access by the user, additional physician support features related to a treatment of a medical diagnosis represented by the specific diagnosis code.

Thus it is one object of the invention to provide a system in which the entry of diagnostic code information enables physician support features thus promoting a high degree of diagnostic code capture.

The additional physician support features may include printing of patient handouts related to the treatment, printing of a prescription for the treatment, creation of a patient diagnosis and medication list, and display of information that assists the physician in optimizing diagnosis and treatment decisions.

Thus it is another object of the invention to provide valuable physician support derived from the entry of the diagnostic information that offsets any additional effort required in diagnostic code selection.

The diagnosis codes may be those of the International Classification of Diseases developed by the World Heath Organization. A set of five alternative access methods are provided to the physician including: 1) the diagnosis codes on that patient's medical problem list, 2) the most frequently used thirty diagnosis codes specific for that physician's area of practice specialty, 3) the next twenty most frequently-used diagnoses codes by that particular physician, 4) a hierarchical system with diagnoses codes organized by category and subcategory and 5) a text search engine.

Thus it is another object of the invention to provide a system that provides extremely high-resolution diagnostic information without disruption or detriment to the physician. This high resolution diagnosis information not only provides better record keeping for outcome-based medicine, but also allows the diagnosis information to be used to better index other relevant information provided to the physician, such as may not be possible with coarser or less accurate diagnosis information.

The selection may be a direct selection of a diagnosis code displayed by the navigation menu or the selection is a direct selection of a non-diagnosis code item pre-linked to a diagnosis code to identify the linked diagnosis code. For example, the navigation menu may display diagnosis codes linked treatment options and the selection may be a direct selection of a treatment option previously linked to a specific diagnosis code.

Thus it is another object of the invention to allow diagnostic information to be entered in the simplest fashion.

The additional physician support features may include a listing of treatment options related to the specific diagnosis code. Further, the listing may be sorted by frequency by which the treatments are used by a group of physicians.

Thus it is another object of the invention to provide a rapid selection of treatment options improved by the previous entry of diagnostic code information.

The terminal server and the hand-held terminal provide interfaces connecting to the Internet and wherein the terminal server connects with the hand-held terminal via the Internet.

Thus it is another object of the invention to provide an extremely cost effective tool for the physician that may connect with a centralized server, which is easily updated, and shared among many physicians.

The hand-held terminal may include a wireless link communicating with the terminal server.

It is another object of the invention to provide a terminal that may be used during the patient examination thus minimizing interruption of the physician workflow.

The display of the hand-held terminal may provide a resolution of at least 600 by 200 pixels.

It is another object of the invention to provide a system that may provide significant text and graphic information to the physician.

The foregoing objects and advantages may not apply to all embodiments of the inventions and are not intended to define the scope of the invention, for which purpose claims are provided. In the following description, reference is made to the accompanying drawings, which form a part hereof, and in which there is shown by way of illustration, a preferred embodiment of the invention. Such embodiment also does not define the scope of the invention and reference must be made therefore to the claims for this purpose.

### BRIEF DESCRIPTION OF THE DRAWINGS

FIG. 1 is a simplified perspective view of the patient-side decision support system of the present invention showing a hand-held terminal for use by the physician at the patient's side as linked through the Internet to a centralized web server;

FIG. 2 is a detailed perspective view of the hand-held terminal showing two alternative means for entering data on a graphic screen of the terminal;

FIG. 3 is a flow chart showing the overarching path of information entry used, in the present invention, to promote capture of detailed diagnosis codes that index physician support materials and that form a basis for outcome-based medicine;

FIG. 4 is a simplified fragmentary representation of a logical table generated by the present invention linking physician, patient, diagnosis, and treatment together;

FIG. 5 is a detailed version of the flow chart of FIG. 3 mapping information entry states to menu screens presented on the device of FIG. 2;

FIGS. 6 through 29 are pictorial representations of menu screens in the information states of FIG. 5;

FIG. 30 is detailed fragmentary view of the logical database of FIG. 4 showing linkage between diagnosis, diagnosis descriptions, major categories, subcategories and diseases with similar treatments;

FIG. 31 is a detailed fragmentary view of the logical database of FIG. 4 showing linkage between diseases with similar treatments and useful physician information and materials; and

FIG. 32 is a detailed fragmentary view of the logical database of FIG. 4 showing information collected for the preparation of a printed prescription together with a stop field allowing the physician to enter an outcome for the particular treatment to enhance outcome evaluation.

### DETAILED DESCRIPTION OF THE PREFERRED EMBODIMENT

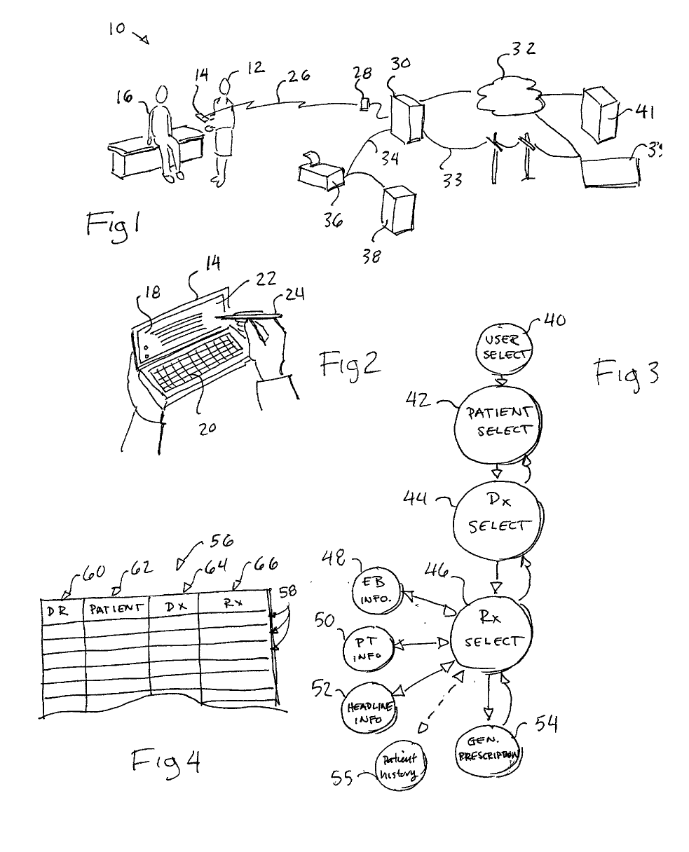

Referring now to FIGS. 1 and 2, a patient-side, decision support system 10 provides a physician 12 with a wireless hand-held terminal 14 that may used during consultation with a patient 16 in the examination room.

In the preferred embodiment, the hand-held terminal 14 is a hand-held personal computer (PC) providing a graphics display screen 18 supporting alphanumeric and graphics display in full color over 640×240 pixels. A keyboard 20 and touch screen overlay 22 allow entry of data either through the keyboard 20 or by means of a stylus 24 according to methods well known in the art.

The hand-held terminal 14 is loaded with and executes software providing a web browser such as Microsoft Internet Explorer operating under a Windows operating system for such handheld devices such as both may be obtained commercially from the Microsoft Corporation of Redmond, Wash. The hand-held terminal 14 includes a radio communication card providing a radio link 26 with an antenna unit 28 communicating with a stationary computer 30.

A hand-held terminal 14 suitable for use in the present invention is commercially available from the Hewlett-Packard Company of Palo Alto, Calif. under the trade name, Jornada 720 Hand-held PC.

Referring to FIG. 1, the stationary computer 30 operates as a router to connect the hand-held terminal 14 both to the Internet 32 and to a local area network 34 connected, for example, to a printer 36 and to other local computers 38 such as one supporting an office system practice management application of a type well known in the art. The stationary computer 30 may also provide a fax connection over a standard phone line 33 as will be described below.

The connection to the Internet 32 and the phone line 33 permit the automatic transfer of prescription information to a pharmacy 39 being either a conventional pharmacy or a semi-automated internal dispensing station using bar code tracking such as is commercially available from DRx, Inc of Skokie, Ill. The connection to the Internet 32 also allows communication between the hand-held terminal 14 and a central web server 41, the latter executing a program may provide the principal functionality of the present invention so that the hand-held terminal 14 may serve essentially as a browser only to review data served by the web server 41. In this case, the stationary computer 30 communicates directly with the web server 41 to support for printing, faxing or communicating with the local office system. Nevertheless, it will be recognized from the following description, that the various functions of the invention may be distributed among different components of the system as is well understood in the art of computer programming. In one alternative embodiment, the central web server 41 may be local to the hand-held terminal 14.

Referring to FIGS. 2 and 3, the hand-held terminal 14 presents the physician 12 with a series of data entry screens associated with primary data entry states 40, 42, 44 and 46. As will be described, the primary data entry states 40, 42, 44 and 46 are ordered so as to integrate logically with the physician's workflow and promote the entry of detailed diagnosis data that may then be used as means for simplifying the selection of a treatment and to link the physician to highly relevant data related to that treatment.

The first primary data entry state is the user selection state 40 allowing entry of user information, being, for example the name of the physician 12. This is followed by the patient selection state 42, in which a patient name is entered. Patient selection state 42 and all subsequent primary data entry states 44 and 46 allow return to user selection state 40 through paths not shown for clarity.

Following the patient selection state 42 is diagnosis code selection state 44 at which detailed diagnosis information is entered in the form of a standard diagnosis code. As will be described, the data entered at the diagnosis code selection state 44 provides an indexing for subsequent treatment selection state 46 at which a treatment may be entered.

The diagnosis entered at the diagnosis code selection state 44 and the treatment entered at the treatment selection state 46 are used to direct the physician 12 to relevant information about either or both per information states 48, 50, 52 and 55. Specifically, these information states include the evidence based information state 48 which provides the physician with current evidence based literature relevant to the diagnosis and treatment, for example, as abstracted from recent medical journals; the patient information state 52 providing hand-outs suitable for the patient, consent forms, and the like; and the headline information state 52 which provides information supporting short headlines which are presented at the treatment selection state 46 without initiative by the physician, and the updating of a patient history state 55 showing recent diagnoses and treatments for a particular patient and normally displayed immediately after the patient selection state 42 as will be described.

From the treatment selection state 46, a prescription may be generated from the data collected at the primary data entry states 40, 42, 44 and 46 as indicated by prescription confirmation state 54.

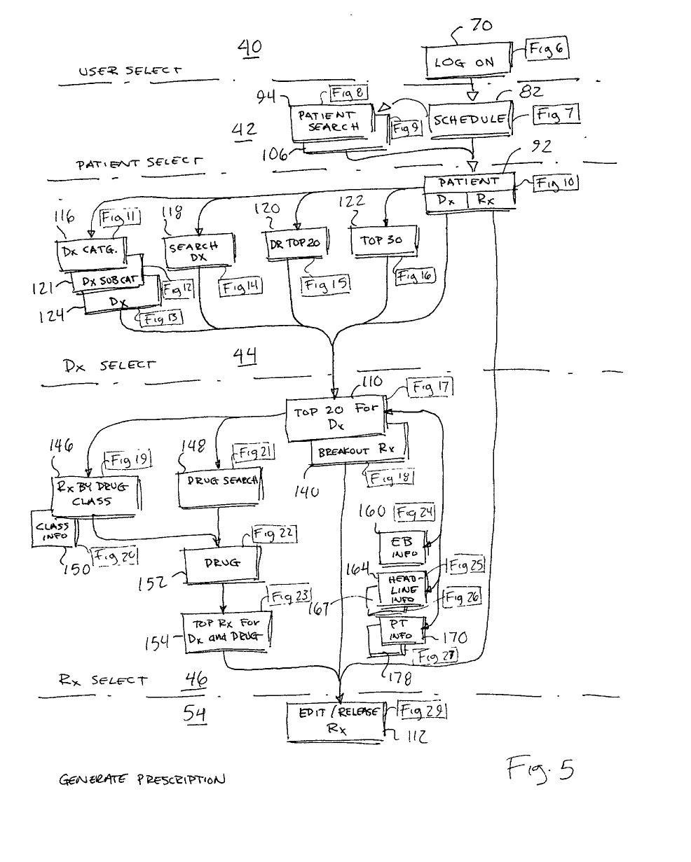

Referring now to FIG. 4, information collected through the states of FIG. 3, are collected in data table 56 capturing in a set of records 58 the attributes of: physician information 60 obtained from the user selection state 40, patient information 62 obtained from the patient selection state 42, the diagnosis information 64 obtained from the diagnosis code selection state 44 and the treatment information 66 obtained from the treatment selection state 46 and confirmed its prescription confirmation state 54. Preferably, data table 56 is arranged as a number of sub-tables linked in relational form as is well understood in the art, and including other attributes logically linked to these records 58 as will be described below. Importantly, the data table 56 may include information related to the ultimate outcome of the treatment, such as a treatment stop reason, as will be described below. Further, the data table 56 provides links through the patient information to other data in possibly external databases providing information about laboratory tests, hospital entry and the like which may serve to further augment the outcome analysis. As will be seen, the data table 56 also provides the mechanism through which physician decision support materials, such as journal articles and the like, are presented to the physician 12 based on the diagnosis information 64 and the treatment information 66 used as an index term. Data table 56 also provides core information used in creating the patient history state 55.

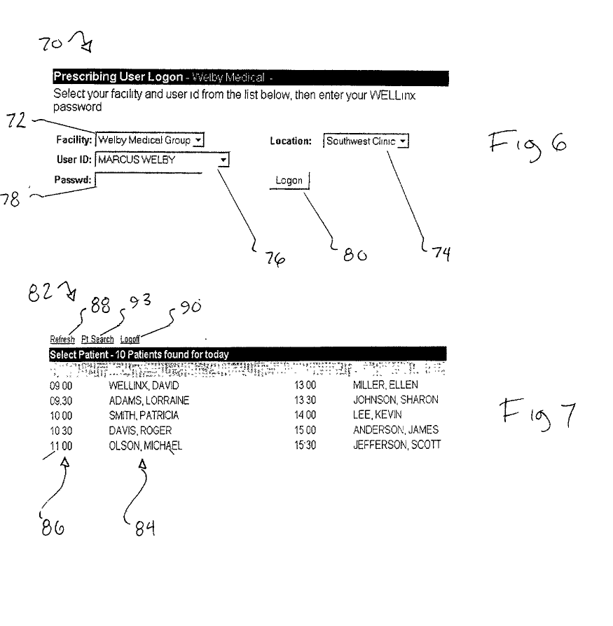

Referring now to FIG. 5, each of the primary data entry states 40, 42, 44 and 46 are implemented through a variety of screens presented to the physician 12 on the hand-held terminal 14 as linked web pages according to methods well understood in the art. The screens are generally associated with sub tables of the data table 56 holding the information presented or collected by the screen, most of which are not shown so as to improve the clarity of the description, but whose content and relationship in the data table 56 will be evident from the description to one of ordinary skill in the art.

Referring to FIGS. 5 and 6, per the user selection state 40, an initial login screen 70 is displayed through which physician information may be entered. The login screen 70 provides a facility entry field 72 and a location entry field 74. These fields are pull down menus of a type well known in the art, providing a list supported by an underlying data sub-table linking physicians, facilities and locations, from which a selection may be made. These fields as well as later described fields, may alternatively be text entry boxes, or other data entry objects as are also known in the art.

The facility entry field 72 and a location entry field 74 serve to identify the office out of which the physician 12 is working and thereby limit the number of physicians that must be listed in a pull down menu which forms the physician entry field 76. The facility entry field 72 and location entry field 74 further providing for identification of a patient schedule for a given physician 12 in the event that the physician 12 works at several different facilities. A password may be entered in password entry field 78 and the data entry is completed when the physician presses the login button 80 using a stylus or keyboard return key. The data sub-table is consulted to confirm a match between the data of the physician entry field 76 and the password of the password entry field 78, upon which, the physician may advance to the schedule screen and the physician information 60 is entered into a new record of the data table 56 of FIG. 4.

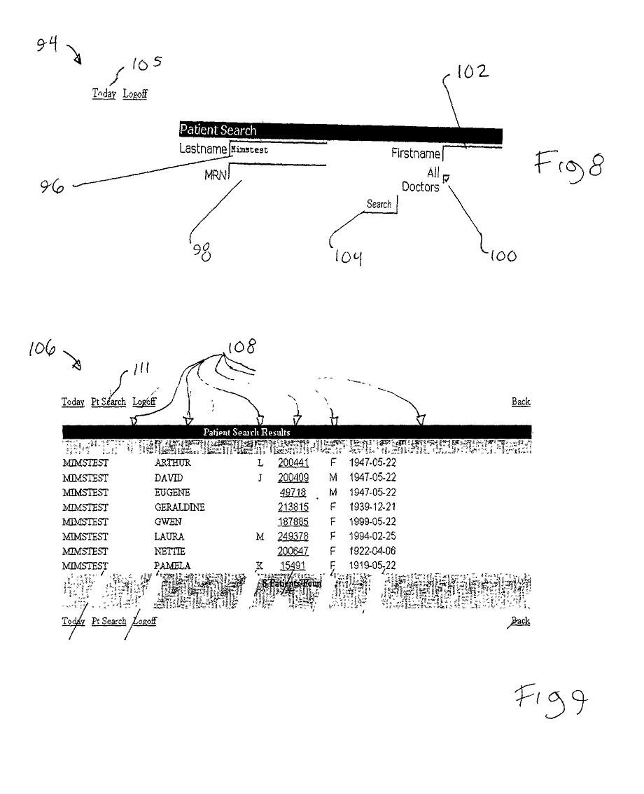

Referring to FIGS. 5 and 7, after completion of the logging-in process, schedule screen 82 is presented to the physician 12. The schedule menu displays from the underlying database that may be part of a third party office practice system of local computer 38, those patients scheduled for the current day for the physician 12 and that facility (identified above) sorted by patient name 84 and appointment time 86 in standard tabular form. The schedule screen 82 provides a refresh button 88 which reloads the schedule as may be desired if a considerable amount of time has passed since the schedule was last reviewed and a logoff button 90 which returns the user to the log-in screen 70. These buttons 88 and 90 are found also in subsequent screens and will not be described as they operate similarly for all screens.

At this time, the physician 12 may select a particular patient from the schedule by touching the patient name 84 with the stylus or through use of the keyboard cursor keys and the enter key according to conventions well known in the art. Alternatively, the physician 12 may invoke a patient search button 93 to search for patients not on the schedule shown in schedule screen 82.

Referring to FIGS. 5 and 8, pressing the patient search button 93 provides the patient search screen 94, which may be used to search for all patients not in the current day's schedule of schedule screen 82. The physician 12 types in the patient's last name in name fields 96 and 102 or optionally the medical record number in MRN field 98. All physicians' patients may be searched for, if the “all doctors” check box 100 is checked, or only patients of the physician 12 (previously captured) may be searched for, by removing the check from the all doctors check box 100. The patient search screen 94 also includes a today button 105, which returns the physician 12 to the schedule screen 82. The search is initiated by pressing the search button 104. As will be understood to those of ordinary skill in the art, this search presents a query to a database of patients and physicians underlying the present invention whose structure is not shown for clarity.

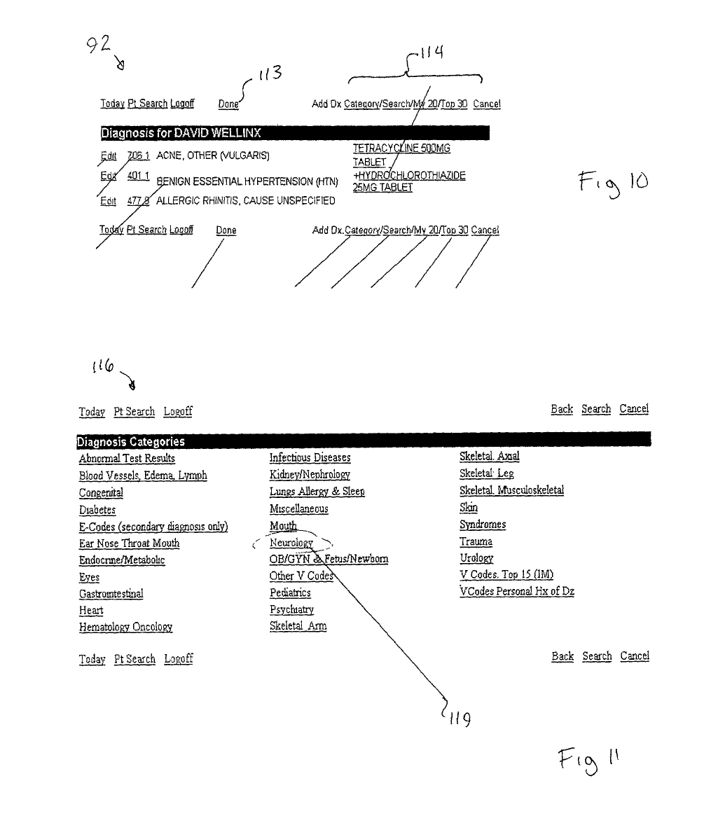

Upon initiation of the search, the physician 12 is presented with a search result screen 106 shown in FIG. 9. The results of the search are shown in columns 108 providing in order the patient's last name, the patient's first name, the patient's middle initial, the medical record number, the patient's sex and date of birth for patients matching the search criteria. A particular patient may then be selected from this list by the physician 12 by clicking on the hyperlinked medical record number of the appropriate patient. This search result screen 106 includes a patient (Pt) search button 111, which allows return to the patient search screen 94.

Referring to FIGS. 5 and 10, either through use of the schedule screen 82 or the patient search process of screens 94 and 106, a patient is selected and entered into the underlying data table 56 (of FIG. 4) and the physician 12 is next presented with the patient history screen 92. The patient history screen 92 presents in tabular form, rows which represent recent diagnoses and treatments for this selected patient in chronological order derived from table 56. Typically each row includes an edit button, a column containing a diagnosis code, a column containing a written description of the diagnosis, and a column containing the treatment. Optionally, but not shown, a treatment stop reason, selected from a menu screen (not shown) may also be presented. Individual rows are dedicated to each visit and each diagnosis and treatment.

The diagnosis codes used in the preferred embodiment are taken from the International Classification Of Disease (ICD) codes developed by the World Health Organization. The treatment may be the name of a prescription drug or may include a nonprescription drug or a nondrug treatment description. Selecting any of the Edit links in the left column takes the physician 12 to a screen (not shown) allowing the physician to suppress the display of that diagnosis entry (so as to simplify the display) without removal, however, of the diagnosis or treatment from the underlying database. General conditions for automatic removal of certain diagnosis codes lines (for example, for certain diagnoses older than a predetermined number of months) can also be used.

Selecting any of the diagnosis codes takes the physician 12 to a listing of the top treatments for that diagnosis code of a Top Rx for Dx screen 110 as will be described below with respect to FIG. 17. Selecting a medication takes the physician 12 to a prescription form prefilled out for that treatment represented by prescription edit screen 112 as will be described below. This option implicitly identifies a diagnosis code of the treatment for entry into the data table 56 of FIG. 4. Alternatively, selecting a treatment and pressing a done button 113 generates a prescription without further steps by the physician 12.

Continuing with the description of the patient history screen 92 of FIG. 10, the patient history screen 92 also includes a set of add diagnosis buttons 114 which allow the physician 12 to make a new diagnosis which will then later be displayed on the patient history screen 92 for the patient. Importantly, the present invention provides a set of different ways to enter a new diagnosis so as to simplify the physician's navigation through the 16,000 possible diagnosis codes.

Referring to FIGS. 5 and 10, the physician 12 may select a diagnosis code by performing a “category search by pressing a “Category” button taking the physician to Dx Category Screen 116. Alternatively, the physician 12 may select a diagnosis code by performing a diagnosis name text search by pressing a “Search” button taking the physician 12 to Dx search screen 118. Alternatively, the physician 12 may select a diagnosis code by reviewing the physician's top twenty diagnoses by pressing a “My 20” taking the physician to Dr. Top Twenty screen 120. Finally, the physician 12 may select a diagnosis code by reviewing the top diagnoses for a group of physicians that have been previously defined, for example, in the physician's practice specialty, by pressing a “Top 30” button taking the physician to Specialty Top Thirty screen 122.

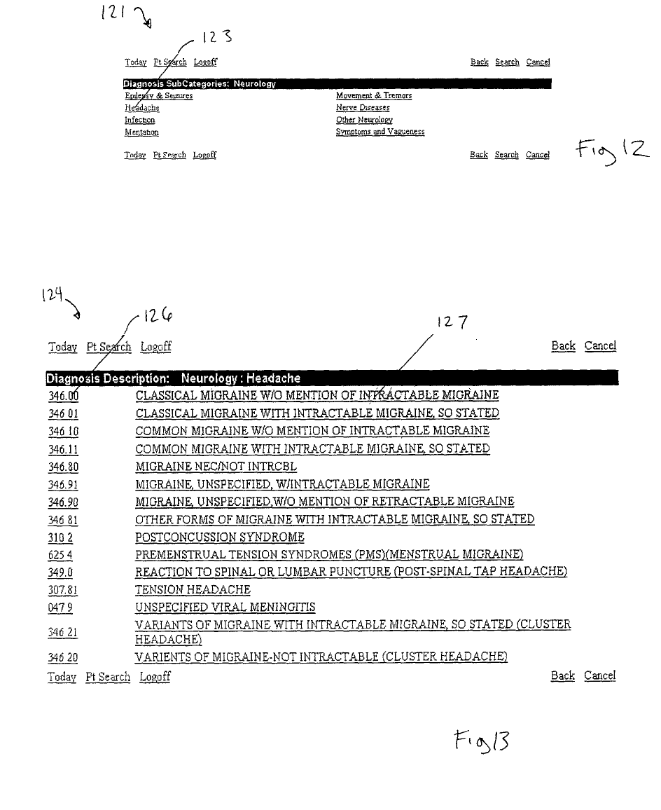

Referring to FIG. 11, the Dx category screen 116 presents the physician 12 with a set of diagnosis categories in tabular form (reflecting an underlying sub-table of data table 56) in which the set of ICD diagnosis codes are collected into logical categories and subcategories in hierarchical fashion. The top level of categories is displayed by the Dx category screen 116 in which the 16,000 diagnosis codes have been collected into thirty-one categories. These categories include, for example, category 119 of NEUROLOGY. Selecting this (or any other) category takes the physician 12 to subcategory screen 121 shown in FIG. 12.

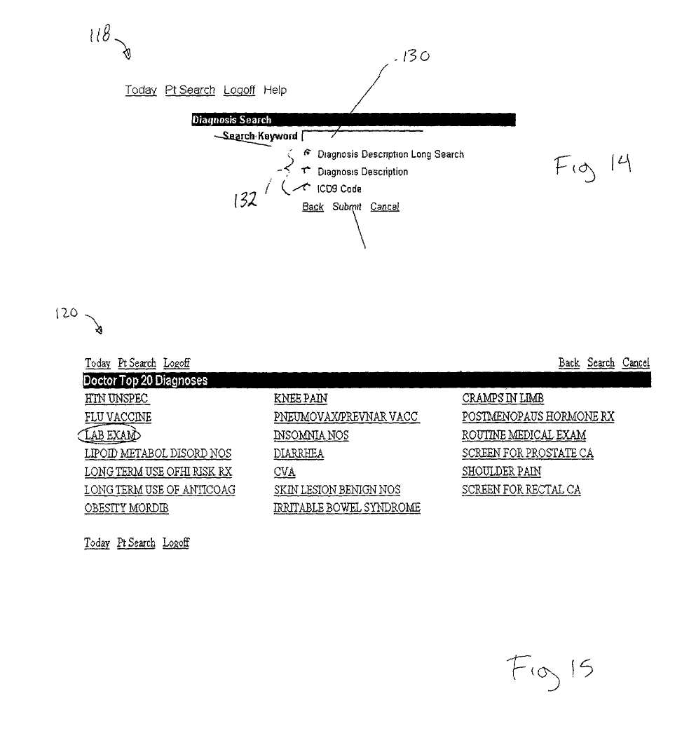

The subcategory screen 121 in this example provides for subcategories under NEUROLOGY category 119, including, for example, the subcategory 123 of HEADACHE. Selecting the HEADACHE subcategory 123 takes the physician 12 to diagnosis code screen 124 shown in FIG. 13.

The diagnosis code screen 124 provides a multi-row table having ICD diagnosis codes 126 in a first column followed by prose descriptions 127 of the diagnosis codes 126 in a second column. Again, the diagnosis codes are linked to descriptions of the diagnosis codes 126 reviewable by selecting the diagnosis code. Selecting the prose description takes the physician 12 to Top Rx for Dx screen 110 as will be described below providing treatment options for that diagnosis.

It will be understood that the number of levels of subcategories between the top level of categories and the bottom level of diagnosis codes may be varied, however, in order to shorten the time required to identify to the proper diagnosis code, one level of subcategories has been found to be preferred.

The present invention also provides for the ability to limit the number of diagnosis codes 126 in the bottom level. Of the 16,000 diagnosis codes, a subset of about 3,000 is used in bottom level diagnosis code screen 124 in the preferred embodiment. The particular subset may be selected according to a known specialty of the physician, for example, pediatrician or internist, and may be contained in a sub-table 129 of the data table 56 shown in FIG. 30.

The sub-table 129 provides for each diagnosis code 126, a brief description 127 of the diagnosis code 127, the name of a major category 123 into which the diagnosis code has been categorized per the Dx Category Screen 116, and the name of a subcategory 119 into which the diagnosis code has been categorized per the subcategory screen 121, if the diagnosis is in the subset of 3000 that have been categorized and displayed in a screen such as screen 124. A blank (null character) in either of the major category 123 or subcategory 119 causes the diagnosis code not to be presented on Dx Category Screen 116 and subcategory screen 121, thus simplifying the presentation of diagnosis codes in categories and subcategories to the physician. The diagnosis codes 126 are nevertheless searchable using the screen 118 as described above This system limits the number of screens necessary to obtain a diagnosis to a reasonable number.

As an alternative to using the diagnosis hierarchy of screens 116, 121 and 124, the physician 12 may prefer a search of diagnosis per Dx search screen 118 shown in FIG. 14. Dx search screen 118 presents a standard database search screen providing for entry of search key words in keyword field 130 and a selection of the search criteria 132 being either a full text description of the diagnosis, a short description of the diagnosis, or the actual diagnosis code 126. All of the former are contained in sub-tables of the data table 56 of FIG. 4. Searching produces a list of search hits (not shown), one of which may be selected to direct the physician 12 to Top Rx for Dx screen 110 as will be described below.

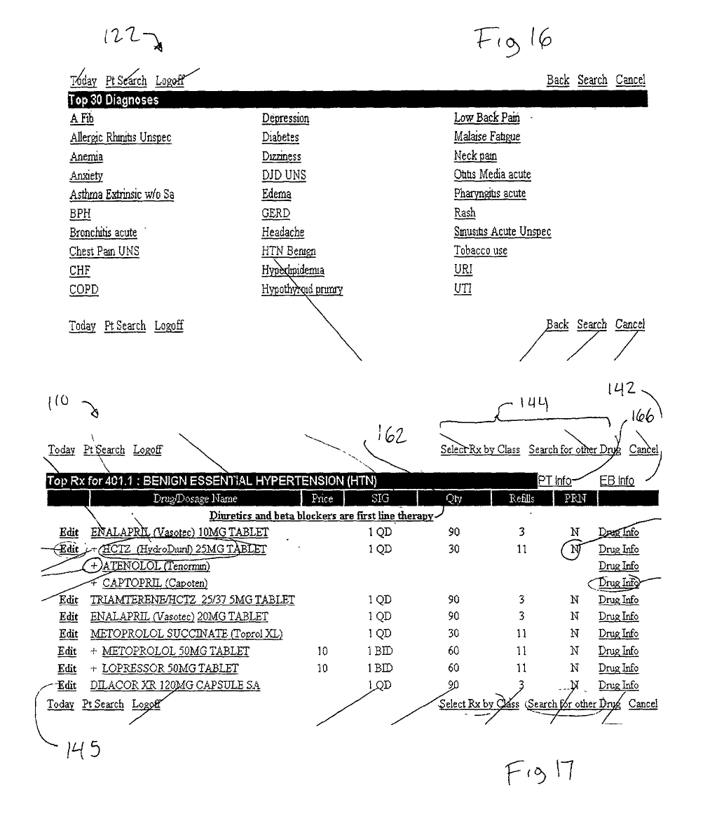

Referring again to FIG. 5, frequently, the physician 12 will chose to identify a particular diagnosis code 126 by using the Dr. Top Twenty screen 120 shown in FIG. 15. The Dr. Top Twenty screen 120 provides that physician's twenty most frequently selected diagnoses that are not already in that doctor's specialty Top 30 diagnosis list. These Dr. Top Twenty diagnoses are culled from the historical record provided by the data table 56 of FIG. 4. Note that these diagnoses are simply the text descriptions of the diagnosis codes 126 and are each linked to an ICD diagnosis code 126 through a data sub-table (not shown). The twenty diagnoses provided by this screen are automatically updated by a search program running on a periodic basis (for example, once per night) at a time when the system is not being used, so as to provide minimal delay in the presentation of this data.

Referring again to FIG. 5, in the final alternative, the physician 12 may select the diagnosis code 126 using the Specialty Top Thirty screen 122 shown in FIG. 16. The Specialty Top Thirty screen 122 shows the thirty diagnoses in text form (linked to underlying diagnosis codes 126) most often chosen by the physician's specialty, e.g. internal medicine. Selecting on any of these diagnoses takes the physician to the Top Rx for Dx screen 110 as will be described below. The top thirty diagnoses can also be updated automatically at off peak times from a particular practice group with the addition of the medical specialty being linked to the physician in the data table 56 or this screen may be a quasi static listing updated at less frequent intervals.

Referring to FIG. 5, as will be understood from the above description, in all cases, a transition from the diagnosis code selection state 44 to the treatment selection state 46 can occur only after a diagnosis code 126 has been identified either through one of the screens 116, 118, 120 or 122 or by implicit linkage when the treatment was selected from patient history screen 92. At the conclusion of the diagnosis code selection state 44, data table 56 will have physician and patient and diagnosis data entered and only treatment is needed. In the case of selection of a diagnosis code implicitly from the patient history screen 92, a treatment has also been selected, therefore a prescription may be immediately generated; however, in the former cases where diagnosis codes 126 are selected via screens 116, 118, 120 or 122, a treatment must be matched to the diagnosis.

Referring now to FIGS. 5 and 17, selection of a treatment can be done from a Top Rx for Dx screen 110. In the preferred embodiment of this invention, the Top Rx for Dx screen 110 initially provides a list of treatments validated for a particular diagnosis by a team of pharmacology experts. As each physician 12 continues to use the system, that doctor 12's preferred treatments for each diagnosis gradually replace more of the preloaded treatments. Alternatively the Top Rx for Dx screen 110 could provide a quasi-static list of treatments validated for a particular diagnosis by experts, regardless of their popularity.

The Top Rx for Dx screen 110 displays a list of the most frequently chosen treatments for the previously entered diagnosis in tabular form. In the preferred embodiment, this list contains ten rows. Each row of the table provides an initial edit button 145 for editing of the data of the row. The remainder of the row provides in sequential columns: a name of a drug representing the treatment, its dosage, price, treatment frequency (SIG), quantity of prescription, refill numbers, a PRN code and a link to drug information as described above. For some drugs, for example, Atenolol, there may be a number of treatment regimes. Accordingly, there are no instructions in the columns to the right of the drug name. If the physician 12 clicks on the hyperlinked drug name, the physician is taken to the Breakout Rx screen 140 as shown in FIG. 18.

The plus sign in front of some medications indicates their availability of In-Office dispensing.

Breakout Rx screen 140 provides for breakout prescriptions for the selected drug in the same format as the Top Rx for Dx screen 110. This nesting of information may be extended for several layers of breakout so as to provide a convenient and intuitive organization of a large number of treatment options.

Referring again to FIG. 17, it will be understood that the rows of the Top Rx for Dx screen 110 provide in effect prewritten prescriptions. Selecting the hyperlinked name of the drug representing the treatment, where there is no breakout, moves the physician 12 to prescription edit screen 112 as will be described below to generate a prescription.

As is the case with the diagnosis, the physician 12 is not limited to this list of treatment options, but by pressing one of the Add Treatment buttons 144 may move to either a search of Treatment By Drug Class screen 146 or a Search For Drug screen 148.

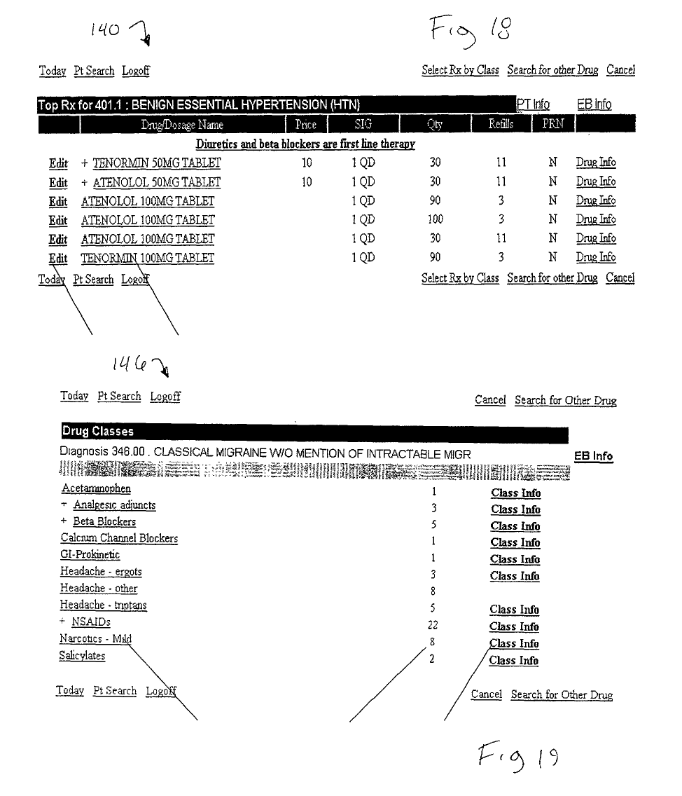

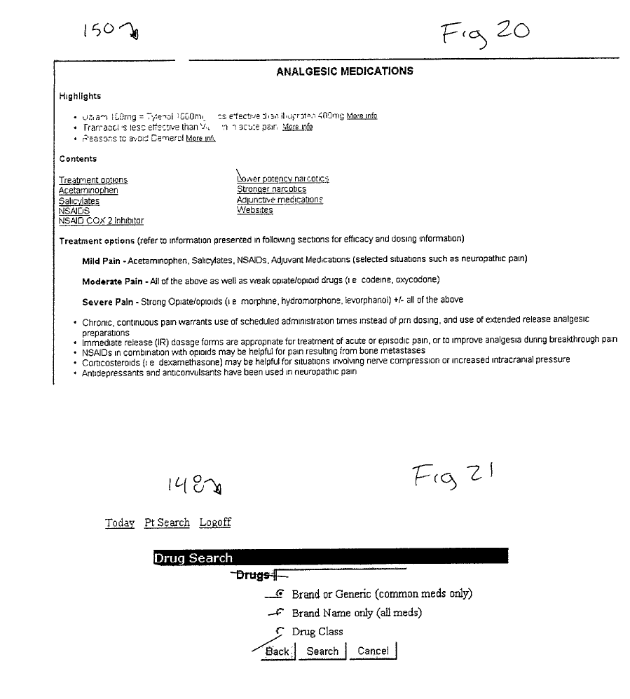

Referring now to FIGS. 5, and 19, Treatment By Drug Class screen 146 provides the physician 12 with a list of treatments for the particular diagnosis organized by drug classes. The information is arranged in tabular form, the first column providing the drug class, the next column providing the number of drugs in the class, and the third column linking the physician 12 to class information, an example of which is shown in FIG. 20 being text, graphics and possible hyperlinks to information about the drug class shown in the Class Information screen 150. Again a prefixing plus sign indicates availability for In-office dispensing.

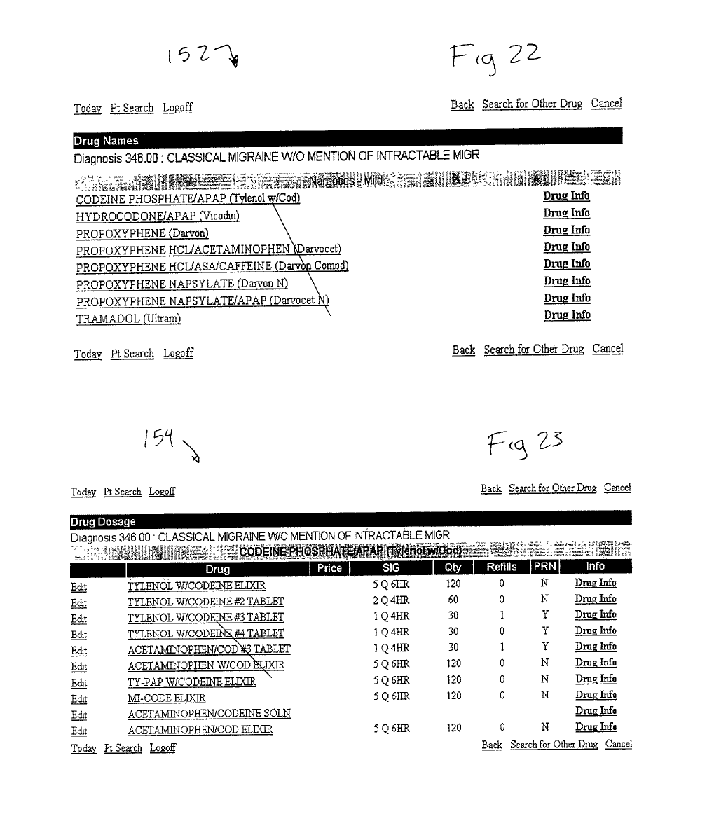

Alternatively and referring to FIGS. 5 and 21, a search for a brand name or drug class may be performed directly using standard search term entry fields shown in FIG. 21 on Search for Drug screen 148.

Using the Treatment By Drug Class screen 146 produces a list of drugs shown in Drug List screen 152 of FIG. 22 providing in tabular form lists of drugs and drug information links as previously described.

Selecting a particular drug moves the physician 12 to a Drug Class Member breakout screen 154 providing frequently used prescriptions for that particular drug. These prescriptions are taken from a static list created by a team of pharmacology experts. Selecting any one of these diagnoses takes the physician 12 to prescription edit screen 112 for generation of the prescription as will be described.

Referring now again to FIGS. 5 and 17, at the treatment selection state 46, critical diagnosis information has been obtained and thus the physician may be directed to important medical information keyed to the particular situation and thus to be useful during examination of the patient. This information is accessed from the Top Rx for Dx screen 110 in one of three ways. First an EBInfo button 142 is provided providing linking the physician 12 to specially prepared evidence-based reports indicated by EBInfo screen 160 shown as an example in FIG. 24. Screen 160 presents the first page of a twenty-six-page document. This first page is organized like the front page of a newspaper, providing headlines for multiple stories, a detailed contents listing, and a set of links to specialty subjects within the evidence-based information report.

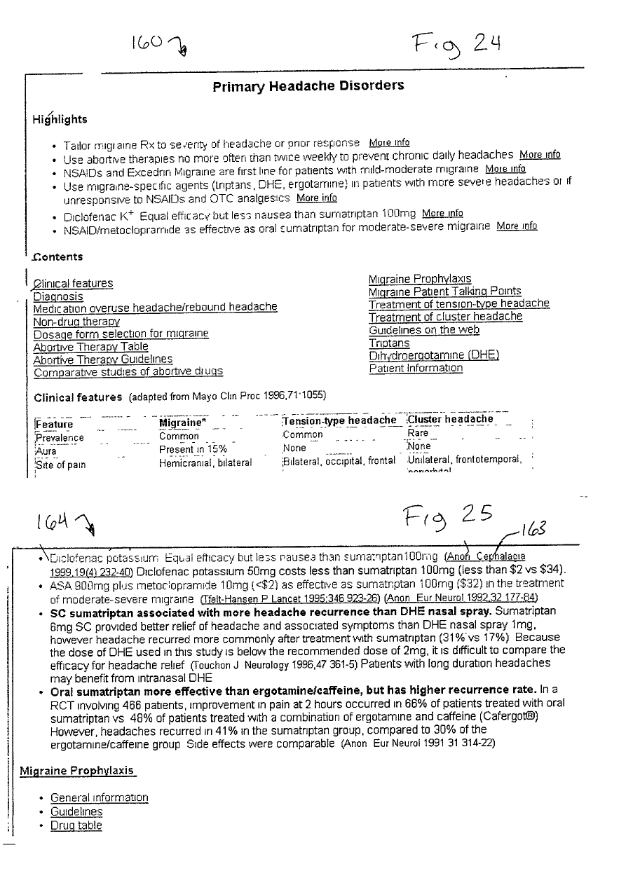

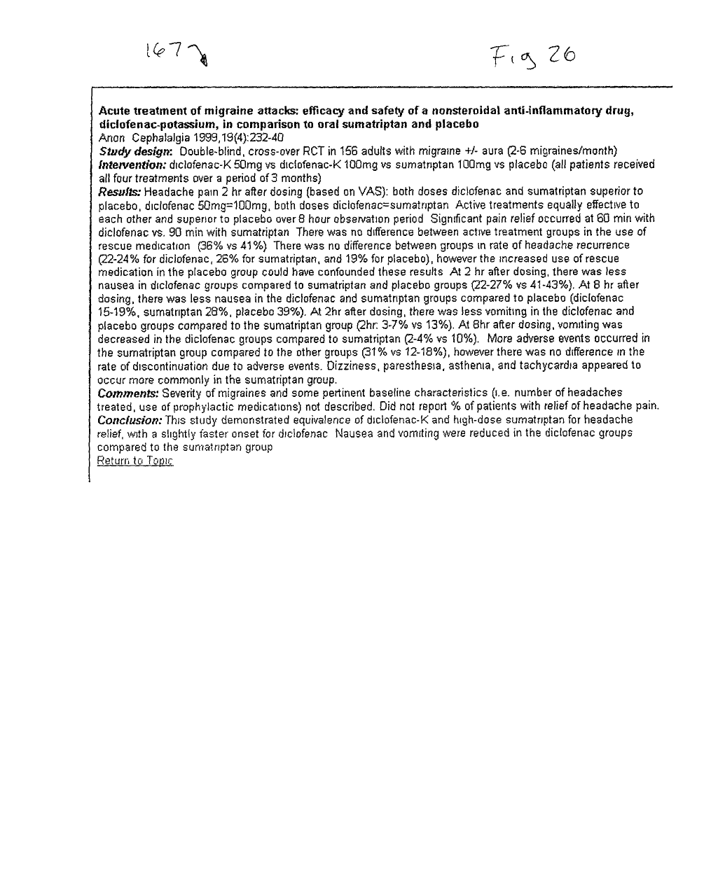

Referring still to FIG. 17, alternatively, a headline 162 may be displayed keyed to the particular diagnosis code 126. Selecting the headline 162 takes the physician 12 to the section of the EBInfo treatise that discusses the issue summarized in the headline in screen 164 shown in FIG. 25 providing additional information and possible citation hyperlinks 163 related to the particular diagnosis code 126. Selecting on a citation hyperlink 163 may take the physician 12 to additional reference 167 of FIG. 26; for example, more detail about a study mentioned somewhere in the body of the EBInfo treatise of FIG. 25, 164.

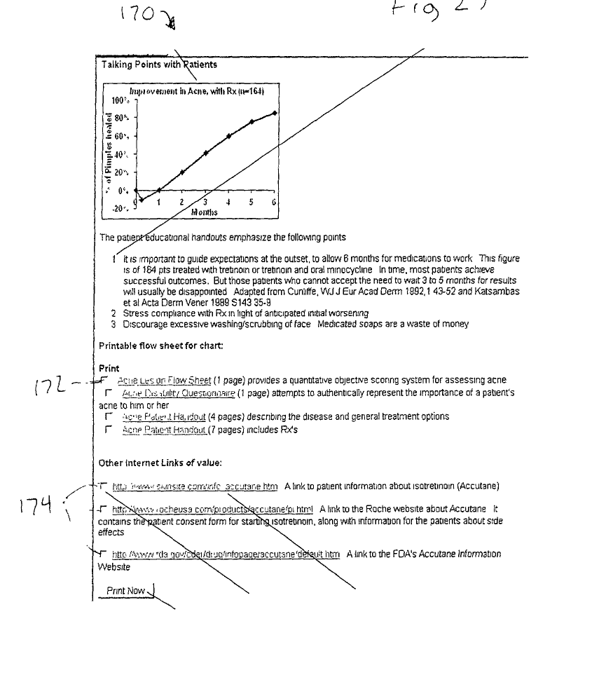

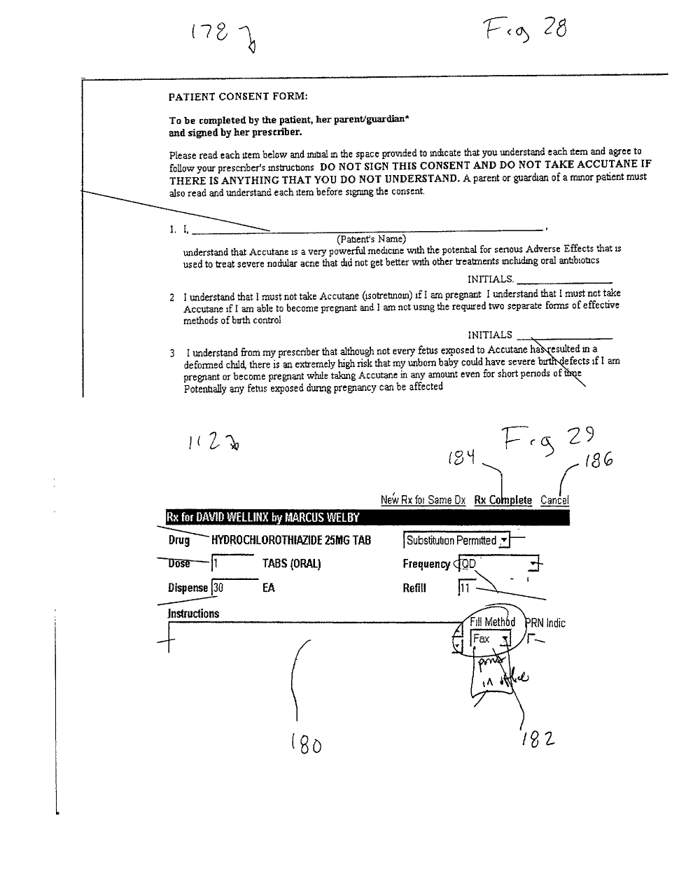

Finally PT Info (patient information) button 166 may be pressed to provide patient information relevant to the diagnosis code 126. Although the diagnosis in FIG. 17 is hypertension, for heuristic reasons the patient information 170 shown in FIG. 27 provides information about use of an acne drug and may be printed by checking print check boxes 172. The patient information additionally provides cross-references to other carefully selected information available at one of the 20,000 websites on the Internet by providing hyperlinks, as in the check boxes 174. An example of additional information is shown by Patient Information screen 178 of FIG. 28 providing a patient consent form, in this case, for a type of acne medicine that causes severe birth defects if taken by women who become pregnant.

Referring again to FIG. 5, at the conclusion of a selection of a treatment per the treatment selection state 46, a prescription edit screen 112 is provided, filled in with the particular treatment selected and allowing for editing. In addition to providing for the fields previously described with respect to the treatment, the prescription edit screen 112 provides for a patient instruction field 180 that may allow the physician 12 to type in instructions that the pharmacist will include on the prescription label, a fill method field 182 allowing for selection of printing, faxing, electronic data interchange of the prescription, or in-office dispensing of the prescription per the channels described with respect to FIG. 1 above. Only after the Rx complete button 184 is pressed is the prescription sent. Pressing the cancel button 186 cancels the prescription and returns the physician 12 to the previous prescription screen.

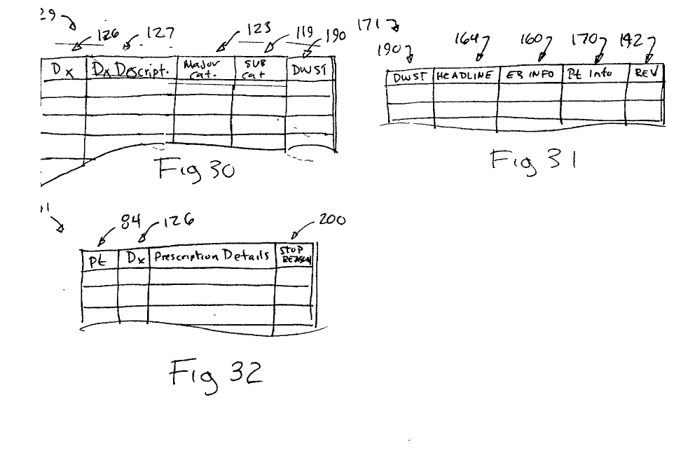

Referring to FIGS. 31 and 30, for efficiency in storage in the data table 56, the patient information 170, the information of the EB screen 160, and the information of the headline screen 164 are linked to a Disease With Similar Treatment Code 190 (DWST) developed by the present inventors to link many different diagnosis with a limited set of treatment options. This DWST code 190 is linked to the patient information 170, the information of the EB screen 160, and the information of the headline screen 164 by sub-table 171 shown in FIG. 31 which also incorporates linkage to a revision date so that these materials may be kept up to date. The DWST code may be linked to ICD diagnosis codes 126 using the sub-table of FIG. 36.

Referring now to FIG. 32, the prescription information is linked to patient information and the diagnosis code 126 and may include a stop reason 200 indicating the reason for the treatment to stop in a prescription sub-table 201. The stop reason 200 may be optionally filled in by the physician at patient history screen 92, which displays previous diagnosis of the patient and requests stop reasons for any diagnosis not having one. This stop reason 200 may be added to the logical data table 56 described in FIG. 4 together with the data of all these components sub-tables to provide a comprehensive view of the treatment and its efficacy.

It is specifically intended that the present invention not be limited to the embodiments and illustrations contained herein, but that modified forms of those embodiments including portions of the embodiments and combinations of elements of different embodiments also be included as come within the scope of the following claims.

We claim:

1. A patient-side decision support system comprising:
a hand-held terminal usable during examination and providing a display and physician input device;
a terminal server communicating with the hand-held terminal and executing a stored program to:
(a) present on the display of the hand-held terminal a navigation menu presenting diagnosis codes representing different medical diagnoses;
(b) accept from the physician input device of the hand-held terminal a selection identifying a specific diagnosis code from the diagnosis codes; and
(c) only after identification of a specific diagnosis code, enable for access by the physician, additional physician support features related to a treatment of a medical diagnosis represented by the specific diagnosis code;
whereby entry of specific diagnosis codes may be promoted.

2. The patient-side decision support system of claim 1 wherein the additional physician support features include printing of patient handouts related to at least one of the diagnosis and treatment.

3. The patient-side decision support system of claim 1 wherein the additional physician support features include printing of a prescription for the treatment;

4. The patient-side decision support system of claim 1 wherein the additional physician support features include display of physician educational information related to at least one of the diagnosis and treatment.

5. The patient-side decision support system of claim 4 wherein the technical references include hyperlinks to other physician educational information.

6. The patient-side decision support system of claim 1 wherein the terminal server further accepts from the physician input device of the hand-held terminal a selection identifying a specific patient, and wherein the additional physician support features include display of a history of related diagnoses and treatments for the patient.

7. The patient-side decision support system of claim 7 wherein the display of a history of related diagnoses and treatments for the patient includes identification of at least one medication used in the treatment

8. The patient-side decision support system of claim 1 wherein the diagnosis codes are codes of the international Classification of Diseases developed by the World Heath Organization.

9. The patient-side decision support system of claim 1 wherein the selection is a direct selection of a diagnosis code displayed by the navigation menu.

10. The patient-side decision support system of claim 1 wherein the selection is a direct selection of a non-diagnosis code item pre-linked to a diagnosis code to identify the linked diagnosis code.

11. The patient-side decision support system of claim 10 wherein the navigation menu displays linked diagnosis codes and treatment options and the selection is a direct selection of a treatment option.

12. The patient-side decision support system of claim 1 wherein the additional physician support features include a listing of treatment options related to the specific diagnosis code.

13. The patient-side decision support system of claim 12 wherein the listing of treatment options related to the specific diagnosis code is sorted in relation to the frequency by which the treatments are used by the physician.

14. The patient-side decision support system of claim 1 wherein the additional physician support features include a listing of treatment options related to the specific drugs.

15. The patient-side decision support system of claim 1 wherein the additional physician support features include access to a searchable database of drugs.

16. The patient decision support system of claim 1 wherein the terminal server and the hand-held terminal provide interfaces connecting to the Internet and wherein the terminal server connects with the hand-held terminal via the Internet.

17. The patient decision support system of claim 1 wherein the hand-held terminal provides a wireless link communicating with the terminal server {types of inputs}

18. The patient decision support system of claim 1 wherein the physician input device is selected from a keyboard and stylus entry device

19. The patient decision support system of claim 1 wherein the display is a graphic display providing for the display of text and images.

20. The patient decision support system of claim 19 wherein display provides a resolution of at least 600 by 200 pixels.

21. The patient-side decision support system of claim 1, wherein the navigation menu lists diagnosis codes based on a frequency of their prior use by a particular physician.

22. The patient-side decision support system of claim 1, wherein the navigation menu lists of diagnosis codes is based on a frequency of their prior use by a predefined group of physicians.
